(19) United States
(12) Patent Application Publication
(10) Pub. No.: US 2006/0102250 A1
(43) Pub. Date: May 18, 2006

(54) Wood splitter

(76) Inventor: Lutz H. Ritzmann, (US)

Correspondence Address: Arlene J. Powers;Gauthier & Connors LLP, Suite 2300, 225 Franklin Street, Boston, MA, 02110, US

(21) Appl. No.: 11/269,105

(22) Filed: Nov. 8, 2005

(30) Foreign Application Priority Data
Nov. 12, 2004 (EP) 04 027 005.0

(51) Int. Cl. B27L 7/00

(52) U.S. Cl. 144/195.7; 144/195.8

(57) ABSTRACT

A wood splitter (1) comprises a splitting wedge (2), a guide bar (3) connected to it at the back (2a) of the splitting wedge (2), and a drop weight (4) movable along the guide bar (3) and encircling the guide bar (3) in cross section. The guide bar (3) is provided with an external thread (3a) at its end area facing the splitting wedge (2) and is screwed into a threaded bore (2b) sunk into the wedge back (2a). There is an intermediate plastic sleeve (5) between the drop weight (4) and the splitting wedge (2), with the longitudinal axis (L) of the guide bar (3) running perpendicularly to the opposing faces (5b, 2b) of the intermediate sleeve (5) and the back (2a) of the wedge. These measures provide a wood splitter (1) with which the risk of damaging the junction between the splitting wedge (2) and the guide bar (3) is distinctly reduced, even with large drop weights (4) and corresponding impact forces.

The invention relates to a wood splitter with a splitting wedge, a guide bar connected to the back of the splitting wedge, and a drop weight encircling the guide bar in cross section and movable along the guide bar, with the guide bar being threaded on the outside at the end area facing the splitting wedge and being screwed into a threaded hole placed in the back of the wedge.

Wood splitters of the type referred to above are known as such, and have proved themselves fundamentally useful in practice with regard to their splitting action and their simple use.

The durability of the connection between the splitting wedge on the one hand and the guide bar on the other hand constitutes a problem with the known wood splitters.

Enormously high forces are effected by the drop weight when it strikes the splitting wedge, which up to now have quickly led to the destruction of the connection between splitting wedge and guide bar, regardless of the structural form in which the splitting wedge and the guide bar were connected to one another. Tons of impact can act on the splitting wedge when the drop weight falls down.

When the splitting wedge has to be pulled out of a piece of wood, a type of load occurs in the area where the splitting wedge and the guide bar are connected that is different from that caused by the dropping motion of the drop weight. This happens because the user strikes the drop weight relatively quickly upward along the guide bar and against an end stop on the guide bar in order to be able to exert a pull on the splitting wedge. This pulling can also damage the junction between the splitting wedge and the guide bar.

The goal of the present invention is to provide a wood splitter of this type in which the risk of damaging or destroying the connection between splitting wedge and guide bar during proper use of the wood splitter is distinctly reduced.

This objective is reached according to the invention by providing that there is a plastic intermediate sleeve between the drop weight and the splitting wedge, and a longitudinal axis of the guide bar runs perpendicular to the faces of the intermediate sleeve and the back of the wedge opposite one another. Lateral bending forces from the impact of the drop weight, which in the past produced substantial problems in the area of the junction between the guide bar and the splitting wedge, are avoided because of the perpendicular orientation of the intermediate sleeve and the back face of the wedge. High operating reliability-of the junction between the splitting wedge and the guide bar is therefore achieved by these structural measures, particularly if the intermediate sleeve encircles the guide bar annularly and thus provides for uniform force distribution.

This configuration of the intermediate sleeve is especially simple to produce and is thus economical, since care only has to be taken here that the flat surfaces are at right angles to the longitudinal axis of the guide bar. Alternatively, there would also be the possibility of designing the faces of the back of the wedge and of the intermediate sleeve opposite one another as truncated cones or crowned, but then in practice there may be transverse loads between the guide bar and the splitting wedge upon impact of the drop weight that damage the junction.

An especially simple design consists of making the opposed faces of the back of the wedge on the one hand and of the intermediate sleeve on the other as flat surfaces. The intermediate sleeve viewed along the longitudinal axis has a constant cross section and thus also provides for a uniform distribution of force. The intermediate sleeve in this case runs concentric to the guide bar, so that only forces pointed in the direction to drive the wedge in occur with the impact of the drop weight, i.e., the splitting wedge is not impacted in the direction transverse to the longitudinal axis of the guide bar as is the case, for example, when one or both surfaces that face one another between the back of the wedge and the intermediate sleeve are not sloped relative to the longitudinal axis of the guide bar.

It is also beneficial if the screw connection is secured by an adhesive, thereby achieving a high load capacity of the junction for tensile forces that come about in the attempt to loosen the splitting wedge from the wood by pushing the drop weight quickly upward against an end stop at the top end of the guide bar. The threading on the guide bar is made as fine-pitch threads for a load-bearing connection, and is screwed into the splitting wedge over a lengthy area.

Other features of the invention are the object of other subclaims.

An exemplary embodiment of the invention is shown in the attached drawings, and is described in further detail below. The drawings show:

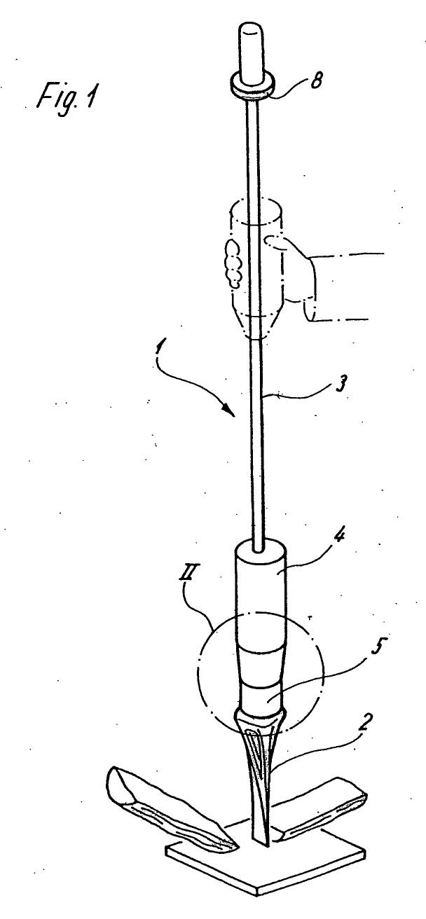

FIG. 1 a perspective illustration of a wood splitter according to the invention,

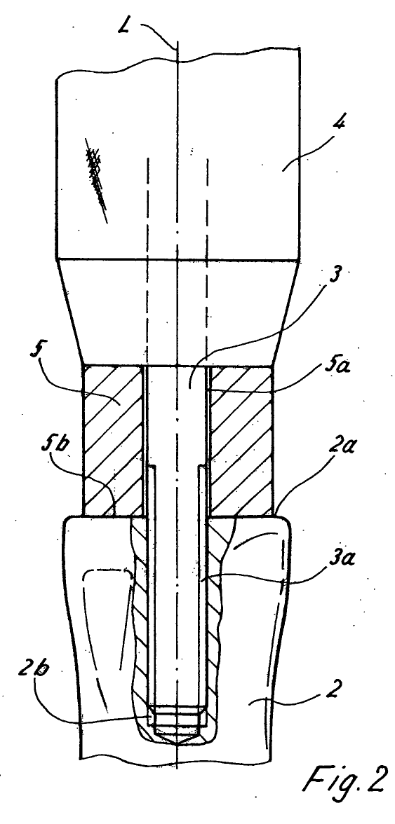

FIG. 2 a partial cut-away view of the junction between the splitting wedge and the guide bar of the wood splitter of FIG. 1.

FIG. 1 shows a wood splitter as a whole, labeled 1, that consists essentially of a splitting wedge 2, a guide bar 3, and a drop weight 4, all of which preferably are made of metal. The splitting wedge 2 has a cutter on the end opposite the guide bar 3, from which the splitting wedge 2 thickens toward a wedge back 2a and is also twisted spirally for good splitting action.

The guide bar 3 is connected to the splitting wedge 2 at the wedge back 2a.

The essentially cylindrical drop weight 4 encircles the guide bar 3 concentrically and can move freely along the guide bar 3.

There is an intermediate sleeve 5 made of plastic with a cylindrical bore 5a between the drop weight 4 and the splitting wedge 2. The intermediate sleeve 5 is concentrically arranged with a form fit or with slight clearance around the guide bar 3 and has a uniform cross section. The surfaces facing one another between the drop weight 4 and the intermediate sleeve 5 are flat and extend perpendicularly to the longitudinal axis L of the guide bar 3.

The guide bar 3 is provided with external threads 3a made as fine-pitch threads on its end facing the splitting wedge 2, and is screwed into a threaded bore 2b sunk in the wedge back 2a. The length of the region that is screwed in is such that the screw connection withstands even long-lasting loads. The screwed-in depth is preferably greater than 3 cm, roughly between 4 and 6 cm. The screw connection between the guide bar 3 and the splitting wedge 2 is additionally secured by an adhesive.

The faces 2a and 5b of the splitting wedge 2 on the one hand and of the intermediate sleeve 5 on the other hand are flat surfaces in the illustrated example of embodiment, with the longitudinal axis L of the guide bar 3 running perpendicularly to these faces 5b and 2a.

When the drop weight 4 is dropped from a position at the upper end area of the guide bar 3, this drop weight strikes the intermediate sleeve 5 resting on the wedge back 2a of the splitting wedge 2. The forces then released act only in the direction of the longitudinal axis L of the guide bar 3; in other words, there are no forces acting that load the splitting wedge 2 perpendicular to the direction of the longitudinal axis L of the guide bar 3. Thus, the junction between the splitting wedge 2 and guide bar 3 is also not loaded by transverse forces, which results in an extremely long service life of the junction between the splitting wedge 2 and guide bar 3.

When the splitting wedge 2 is to be extracted from a block of wood to be split, the drop weight 4 is pushed rapidly upward by hand along the guide bar 3, and it strikes against an end stop 8 there, with the stopping surfaces on the end stop 8 and the drop weight 4 again being perpendicular to the longitudinal axis L of the guide bar 3. The tensile forces then occurring, again being active only in the longitudinal direction of the guide bar 3 in the area of the screw connection, are absorbed permanently by the described security measures for the screw connection. The security measure, as already stated, is the cementing in the threaded area.

The intermediate sleeve 5 is preferably made of extremely high-impact-strength plastic. The collision of metal on metal when the impact weight 4 drops is prevented by the intermediate sleeve 5 and thus the noise involved in metal-on-metal collision is also prevented.

1. The wood splitter with a splitting wedge, a guide bar connected to it at the back of the splitting wedge, and a drop weight movable along the guide bar and encircling the guide bar in cross section, with the guide bar being provided with an external thread at its end area facing the splitting wedge and being screwed into a threaded bore sunk into the wedge back, wherein there is an intermediate plastic sleeve between the drop weight and the splitting wedge, and a longitudinal axis (L) of the guide bar runs perpendicularly to the opposing faces of the intermediate sleeve and the back of the wedge.

2. The wood splitter according to claim 1, wherein the opposing faces of the intermediate sleeve and the back of the wedge are flat parallel surfaces.

3. The wood splitter according to claim, wherein the screw connection between the guide bar and the splitting wedge is secured by an adhesive.

4. The wood splitter according to, claim 1 wherein the external thread on the guide bar is a fine-pitch thread.

5. The wood splitter according to, claim 1 wherein the external thread on the guide bar is screwed into the threaded bore on the splitting wedge for a length of more than 3 cm, preferably between 4 and 6 cm.

6. The wood splitter according to claim 1 wherein the intermediate sleeve is made of a high impact strength plastic.

7. The wood splitter according to claim 1 wherein the splitting wedge has a splitting cutter, from which the splitting wedge thickens toward the back of the wedge, and is twisted spirally.

8. The wood splitter according to claim 1 wherein the intermediate sleeve is adjacent to the wedge.
